(19) United States
(12) Patent Application Publication
(10) Pub. No.: US 2026/0246349 A1
(43) Pub. Date: Aug. 20, 2026

(54) PERMANENT MAGNET AND METHOD FOR PRODUCING A ROTOR OF A DYNAMO-ELECTRIC MACHINE HAVING SUCH PERMANENT MAGNETS

(71) Applicant: Innomotics GmbH, 90441 Nümberg (DE)

(72) Inventors: KLAUS BÜTTNER, Hollstadt (DE); KLAUS KIRCHNER, Ostheim (DE); MATTHIAS WARMUTH, Windshausen (DE)

(73) Assignee: Innomotics GmbH, 90441 Nümberg (DE)

(21) Appl. No.: 19/161,151

(22) PCT Filed: Jan. 8, 2024
(86) PCT No.: PCT/EP2024/050288

§ 371 Date: Aug. 29, 2025

(30) Foreign Application Priority Data
Mar. 3, 2023 (EP) 23159831.9

(51) Int. Cl. H02K 15/035; H02K 15/038; H02K 15/40

(52) U.S. Cl. CPC H02K 15/035; H02K 15/038; H02K 15/40

(57) ABSTRACT

In a method for producing a rotor of a dynamo-electric machine, a magnet pocket and flux barriers are formed in an axial circumferentially closed recess of a laminated core for receiving a permanent magnet with two opposite flux barrier sides facing flux barriers, a delivery side and a thrust side on two opposite sides, and an air gap side and an axle side. Portions of the delivery side and/or adjoining regions of a side in a magnetic flux are formed of curved or fluidic configuration. Adhesive is added to the delivery side and the permanent magnet is pushed with the delivery side axially into the magnet pocket such that the adhesive is distributed via a gap between the air gap side and the magnet pocket and a gap between the axle side and the magnet pocket without wetting the flux barriers, thereby bonding the permanent magnet in the magnet pocket.

The invention relates to a permanent magnet, to a method for producing a rotor having such permanent magnets, and to a dynamo-electric machine having such a rotor, and to the use of such a dynamo-electric machine.

Rotors, e.g., of synchronous motors, in particular for industrial applications, are conventionally constructed with buried permanent magnets in the rotor. For this purpose, axially extending recesses are provided in the laminated rotor core, wherein the permanent magnets are pushed axially into magnet pockets, as part of the recess. For easier assembly, the height of the permanent magnet, as viewed substantially in the radial direction, is caused by the manufacturing to be somewhat smaller than the height of the magnet pocket, and therefore joining gaps arise.

The permanent magnets are conventionally fixed in the recess by an adhesive or potting compound. The permanent magnets are adhesively bonded on their outer surface, and therefore the joining gap, inter alia, contains adhesive.

There are various methods and adhesive bonds. The following methods are known.

The magnet pockets in the laminated rotor core are fitted in advance with the permanent magnet. Subsequently, a low viscosity adhesive is applied to the end face, the adhesive infiltrating or capillating into the joining gaps due to gravity so that the permanent magnet is adhesively bonded. It is not possible to avoid adhesive escaping on the other end face and possibly into the flux barriers. In order also to avoid solling the tool, a separation is provided for this purpose by the use of silicone films or silicone disks. In addition, the laminated rotor core is preheated for this technique in order thereby to obtain a lower viscosity for the adhesive, with the intention being to promote the capillating into the joining gap.

In another method, the magnet pockets are partially filled in advance with adhesive. The permanent magnets are then pushed in so that the adhesive is displaced and the permanent magnet is embedded in the adhesive. The tool here is coated with a protective layer primarily made of silicone so that the surface wetted by adhesive can easily be cleaned after the joining process. Excess adhesive is then scraped off. In this method, it is also not possible to avoid that the flux barriers placed on the sides of the magnet pockets are likewise automatically filled with adhesive, which leads to an increased and difficult to calculate material consumption of the adhesive. In order to accelerate the solidification of the adhesive, thermal processes, such as curing in a furnace, frequently follow.

DE 10 2012 215 084 A1 describes another method. In this case, the recesses in the laminated core of the rotor are supplied with potting compound via additional covering disks on the end faces.

Taking this as the starting point, the invention is based on the object of creaing a rotor of a dynamo-electric machine, in particular a permanently excited synchronous machine, which is simple to produce and avoids the above-mentioned disadvantages.

The object is achieved by a permanent magnet with an, in particular cuboidal, basic structure, for a rotor of a dynamo-electric machine, in particular a permanently excited synchronous machine,
having two opposite sides (flux barrier sides) facing flux barriers, two opposite sides (delivery side and thrust side), facing end faces, and two magnetic field sides (air gap side and axle side),
wherein portions of the delivery side and/or adjoining regions of at least one side located in the magnetic flux, such as the air gap side and/or axle side, have a configuration at least in sections, in particular a curved/fluidic configuration in sections.

The object is also achieved by a method for producing a rotor having buried permanent magnets according to the invention,
wherein in axially extending, circumferentially closed recesses of a laminated core of the rotor, which recesses have a magnet pocket and flux barriers,
wherein the permanent magnet is provided with two opposite sides (flux barrier sides) facing flux barriers, two opposite sides (delivery side and thrust side), facing end faces, and two magnetic field sides (air gap side and axle side),
wherein portions of the delivery side and/or adjoining regions of at least one side located in the magnetic flux, such as the air gap side and/or axle side, have a configuration at least in sections, in particular curved/fluidic configurations in sections,
wherein, with adhesive being added to the delivery side of the permanent magnet, the latter is pushed with the delivery side in front axially in each case Into the magnet pocket and adhesively bonded there in the magnet pocket.

The object is also achieved by a method for producing a rotor having two or more laminated cores which are fitted according to the invention and are assembled axially to form an overall laminated core in such a way that, as viewed axially, there is a staggered arrangement in that the laminated cores, as viewed in the circumferential direction, are assembled axially offset by a predeterminable identical or different angle, with it being possible for the angle to be 0° or up to 30°.

The object is also achieved by a dynamo-electric machine, in particular permanently excited synchronous machine, having a rotor according to the invention.

The object is also achieved by the use of a dynamo-electric machine according to the invention, in particular permanently excited synchronous machine, as a drive of pumps, fans, compressors, roller conveyors and delivery systems.

In order to obtain fixing according to the invention of permanent magnets in recesses in a laminated core of a rotor by means of a method in which it is possible to adhesively bond the permanent magnets without a complicated cleaning process at the end faces of the laminated core of the magnet pocket or of the tool being required, the permanent magnets according to the invention for this purpose will firstly be described.

The permanent magnet according to the invention has a cuboidal basic structure with six sides. These sides are provided with the following designations also with reference to their later use. The mutually opposite sides of the permanent magnet that in later use in the laminated core of the rotor face the flux barriers are referred to as flux barrier sides. The mutually opposite sides of the permanent magnet that in later use in the laminated core of the rotor are aligned axially parallel and face the end faces of the laminated core are referred to as the delivery side or thrust side. The mutually opposite sides of the permanent magnet that in later use in the laminated core of the rotor lie in a magnetic flux are referred to as the air gap side or axle side.

According to the invention, portions of the delivery side and adjoining regions of at least one side located in the magnetic flux, i.e., either the air gap side and/or axle side, during the production of the permanent magnet are materially abraded or configured in sections, the process fluidically shaping the cuboidal basic structure. By means of this shaping process, during an axial movement of the permanent magnet in the magnet pocket, an adhesive placed onto the delivery side of the permanent magnet is distributed via the gaps between the air gap side and the inner side of the magnet pocket and the axle side and the inner side of the magnet pocket without wetting the flux barriers.

In other words-at least the delivery side of the permanent magnet has a hydrodynamic contour.

The edges or the portions between the delivery side and at least one magnetic field side have a fluidic or curved configuration in order, when the permanent magnet is pushed axially into an axially extending recess, to distribute sufficient adhesive between the magnetic field sides and the corresponding inner sides of the magnet pockets.

The edges have flat surface elements or curved transitions from the delivery side to at least one magnetic field side.

In order to ensure that the adhesive is distributed, the portion between the delivery side and the magnetic field sides is configured symmetrically.

In another embodiment, it may also be advantageous if the portion between the delivery side and the magnetic field sides is configured asymmetrically, which in the extreme case can also mean that only a portion between the delivery side and a magnetic field side has such configurations.

In another embodiment, the delivery side may additionally have at least one transverse channel or trough which extends from one magnetic field side to the other on the delivery side. This is also used for distributing the adhesive.

In another embodiment, at its edges toward the flux barrier sides, the delivery side has ridges which contribute to distributing adhesive and avoid the adhesive entering the flux barriers in the recesses in the laminated core of the rotor. Said ridges are important especially also if the delivery side underwent a comparatively small amount of material abrasion.

The ridge does not inevitably protrude beyond the delivery side, but rather forms a flat surface with other configuration elements of the delivery side.

Said ridges at the edges of the delivery side and the flux barrier sides are therefore “remnants” of the cuboidal basic structure which has been formed. The extent of the ridges runs from one magnetic field side to the other.

The material abrasion or configuration on the delivery side of the permanent magnet may also reach over the entire width of one or both magnetic field sides so that there are no ridges.

The configuration according to the invention of the permanent magnets relates not only to the substantially cuboidally configured permanent magnets, but also to other configurations of permanent magnets, for example shell-shaped permanent magnets or “bread-loaf” permanent magnets.

The permanent magnets can be constructed from rare earths; it is also possible to form said permanent magnets from ferrite. Similarly, various coatings, such as epoxy or a passivation are possible in order to avoid possible environmental influences, e.g., rust phenomena on the permanent magnets.

According to the invention, to fix said permanent magnets in the recesses in the laminated core of the rotor, a method is described in which it is possible to adhesively bond the permanent magnets in their respective magnet pockets without a complicated cleaning process at the end faces of the laminated core of the magnet pocket or of the tool being required.

A recess in the laminated core of the rotor has a magnet pocket for receiving a permanent magnet, and flux barriers adjoining the magnet pocket.

It is advantageous here to avoid, inter alia, the outer flux barriers of the recesses being filled with adhesive. It is thus avoided that adhesive escapes at the end faces of the laminated core and at the two flux barrier sides of the permanent magnet. This promotes an exact metering of the adhesive per recess, or magnet pocket and thus per rotor.

Preheating of the adhesive and/or of the laminated core is not required either since the adhesive is introduced by movement of the permanent magnet and therefore a contour-induced hydrodynamic effect is used. In addition, a uniform planar adhesive layer between at least one magnetic field side and the corresponding side of the magnet pocket is ensured.

The method according to the invention for adhesively bonding said permanent magnets proceeds as follows.

The permanent magnet according to the invention is firstly fitted from one side onto the magnet pocket of a recess, in particular pushed in approx. 2 to 3 mm. This side-the push-in side-of the magnet pocket is therefore covered by the contour of the delivery side of the permanent magnet, with only the flux barriers of the recess being free and remaining free. An additional silicone covering for sealing purposes is not required.

An adhesive or a potting compound is now applied to the delivery side of the permanent magnet. This can be undertaken by one or more nozzles, preferably in the central region of the delivery side of the permanent magnet. On the delivery side, on the surface there of the permanent magnet and adjoining regions of at least one side located in the magnetic flux, Le., either the air gap side and/or axle side, during the production of the permanent magnet material is abraded or configured in sections. By means of this shaping process, during an axial movement of the permanent magnet in the magnet pocket, an adhesive placed onto the delivery side of the permanent magnet is distributed via the gaps, in particular joining gaps, between the air gap side and the inner side of the magnet pocket and the axle side and the inner side of the magnet pocket without wetting the flux barriers.

By means of these special contours, the adhesive is introduced into the gaps which distribute the adhesive between the air gap side and axle side of the permanent magnet and the corresponding inner sides of the magnet pocket as the permanent magnet is displaced further axially into the magnet pocket.

The axial movement of the permanent magnet in the magnet pocket results in a predeterminable distribution of adhesive which depends on the volume flow of the adhesive and the axial fitting speed of the permanent magnet in the magnet pocket. With the viscosity of the adhesive being set, it is also possible to influence the distribution of the adhesive in the bevel and thus the planar impingement of the adhesive, In particular on the air gap side and axle side of the permanent magnet.

In one exemplary embodiment, the contour on the delivery side does not reach as far as the side surfaces of the permanent magnet that face the flux barriers (flux barrier sides), but rather is in each case ended with an at least narrow ridge. It is thus avoided that, even during an axial movement of the permanent magnet into the magnet pocket, the adhesive runs laterally into the flux barriers and would no longer be available for the adhesive process.

In a further exemplary embodiment of the permanent magnets, the contour reaches on the delivery side of the permanent magnet as far as the side surfaces of the permanent magnet that face the flux barriers (flux barrier sides).

By means of at least one trough or transverse channel which extends on the delivery side of the permanent magnet and into which adhesive is at least predominantly supplied, it is possible to supply the adhesive process with sufficient adhesive with only one nozzle. This is important in particular whenever the magnet height, i.e., the distance between the magnetic field sides, is greater than 4 mm.

This trough or this transverse channel does not have to reach from one magnetic field side to the other; reduced lengths are also possible. Similarly, the cross section of the trough or of the transverse channel can change from one magnetic field side to the other magnetic field side, or can have a different contour and/or cross-sectional area.

Other geometries of the delivery side of the permanent magnets and/or adjoining regions, such as the magnetic field sides, for distributing the adhesive are also possible.

It is thus also conceivable to supply the two bevels and/or the two magnetic field sides with different quantities of adhesive by, for example, the bevels being configured differently. The magnetic field sides facing the inner sides of the magnet pocket can thus be supplied with different volumes of adhesive, e.g., the air gap side of the permanent magnet can have only 30% of the adhesive volume, while the axle side of the permanent magnet has 70% of the adhesive volume.

By means of this method, the adhesive is thus placed and fixed with the permanent magnets according to the invention in the magnet pocket in predeterminable quantities by means of a hydrodynamic effect between the permanent magnet and inner side of the magnet pocket. The contour on the delivery side of the permanent magnet, in particular the bevels on the permanent magnet, form a type of deposit, the “filling level” of which is influenced, inter alia, by the displacement speed of the permanent magnet in the magnet pocket.

The formation of bubbles or imperfections on the adhesive surfaces between a magnetic field side and the corresponding sides of the magnet pocket of the laminated core are thus avoided.

The adhesive on the outer sides of the permanent magnet is prevented from running away into the flux barriers by the special edge geometry or bevel geometry on the delivery side of the permanent magnet, the geometry not extending as far as the flux barrier sides. According to the invention, the flux barriers therefore remain free from adhesive. Sealing at the tool of the device, by means of silicone, In particular on the push-in side, is not required. An outlay on cleaning of the tool, and scraping off on the side of the recess opposite the push-in side are not required.

The filling/providing of the adhesive in the magnet pocket on the delivery side of the permanent magnet can carry on continuously as the permanent magnets are being pushed in axially. In the process, the nozzle and the push-in element moving the permanent magnet can be moved in parallel or synchronously such that the necessary volume of adhesive in the gap or the gaps between the inner side of the magnet pocket and the magnetic field sides can be uniformly maintained.

In order to avoid the permanent magnet jumping ahead because of its magnetic tensile forces in the magnet pocket, in particular in the axial direction, counterholders of the device can be provided on the delivery side of the permanent magnet or clamps can be provided on the thrust side of the permanent magnet, and therefore, during its fitting, the permanent magnet is fixed in the axial direction in the tool of the device.

This permits a uniform pushing operation at a predeterminable speed without the permanent magnet carrying out undesirable axial self-movements in the magnet pocket.

If the permanent magnet is pushed completely or virtually completely into the magnet pocket, the delivery of the adhesive from the nozzle is broken off. The protruding drop of adhesive finally flushes out the bevel and adhesive does not protrude over the upper side or end face of the laminated core/partial laminated core.

In order to ensure handling of the rotor cores, which are fitted with permanent magnets, directly after the fitting process without interruptions, there is the possibility, after the process to fit the magnet pocket with the permanent magnet- or split into two temporally separate portions at the beginning and end of the fitting process-to subject the axial ends of the magnet pocket, I.e. especially the adhesive surface, to UV light.

For this purpose, the adhesive is equipped with UV-hardening substances. The rotor fitted with permanent magnets is suitable for further handling and can completely harden through at room temperature.

In a further embodiment, adhesive with UV-hardening substances is administered especially with a dedicated nozzle at least for a predeterminable period at the beginning and end of the process. Otherwise, the nozzle is used with adhesive without UV-hardening substances in the axially central portion of the magnet pocket.

The method according to the invention can be used in poles of the rotor that have one or more recesses per pole, and the arrangement of said recesses is in each case tangential, V-shaped, U-shaped or double U-shaped, etc.

According to method steps described above, this is carried out for each recess of the laminated core of the rotor. After a recess is fitted, the rotor is rotated by a predeterminable angle in order, according to the invention, to fit the next recess of the laminated core.

Depending on the device used, a plurality of recesses of a laminated core may also be fitted simultaneously. Similarly, it is possible to fit a plurality of laminated cores simultaneously.

The axial length of the permanent magnets corresponds to the axial length of a laminated core. In order also to obtain axially longer laminated cores of the rotor, said laminated cores can be assembled from a plurality of individual laminated cores. This makes it possible to construct the rotor in staggered form. Each partial laminated core therefore has to be rotated by a predeterminable angle in the circumferential direction in relation to the axially following partial laminated core.

According to this method, the permanent magnets can be pushed magnetized, partially magnetized or unmagnetized into the magnet pockets and may then later possibly be completely magnetized.

The permanent magnets are supplied from a magazine which is oriented in such a manner that the pushed-in permanent magnets thus generally bear against the radial outer side of the magnet pocket.

The adhesion of the permanent magnet being pushed in on the outer side of the magnet pocket can be secured by a holding contour of the magnet pocket in the rotor lamination. Holding elements are provided at the edges of the magnet pocket toward the flux barriers which face the outer circumference of the rotor, i.e., the air gap of the dynamo-electric machine.

Sald holding elements additionally also increase the short-circuit resistance of the dynamo-electric machine, in particular a permanently excited synchronous motor with buried permanent magnets.

Instead or in addition, such a reinforcing effect can also be achieved by tool technology measures. This may be a magnetic core for closing the magnetic circuit, or additional electromagnetic coils pulling the permanent magnets onto the outer side of the magnet pocket.

The bearing of the permanent magnets is of advantage with regard to the fact that the centrifugal force acting on the permanent magnets during the operation of the dynamo-electric machine is better supported by the lamination geometry, or else, in the manufacturing process, the distribution of the adhesive can be oriented toward the determined gap.

Preheating of the core is not required since, in this adhesive method, the adhesive is wedged into the adhesive gaps by hydrodynamic pressure formation, and therefore, in comparison to conventional methods, there is no longer the high dependency of the functions of gravity effect, capillary effect and viscosity of the adhesive.

The features of the embodiments described previously and below can be combined as desired. Similarly, individual features of the respective embodiments can also be combined with individual features of another embodiment without departing from the essence of the invention.

The invention and further advantageous refinements of the invention will be explained in more detail on the basis of exemplary embodiments shown in principle in the drawings, in which:

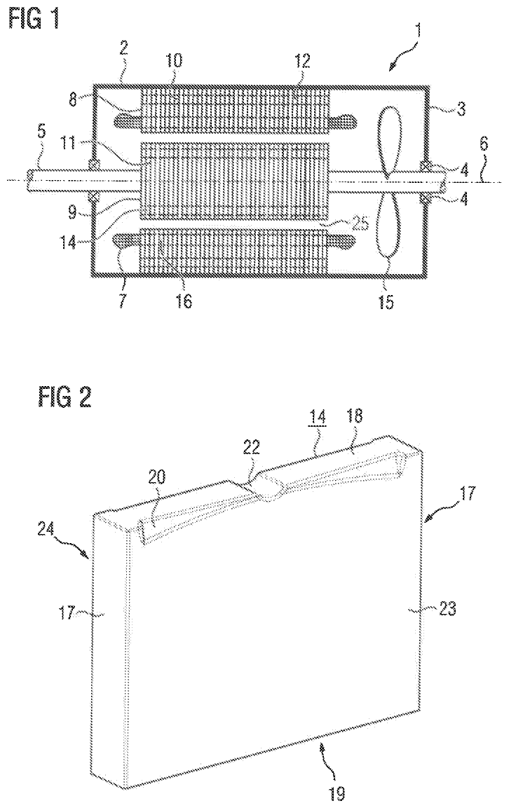

FIG. 1 shows a basic longitudinal section of a dynamo-electric machine,

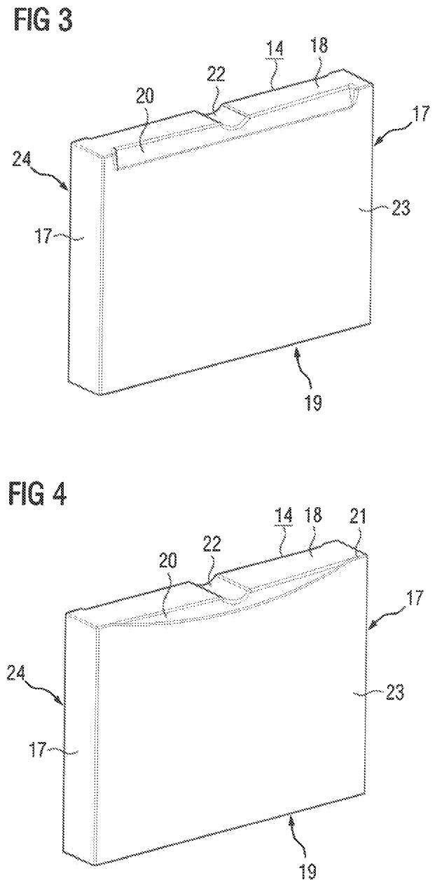

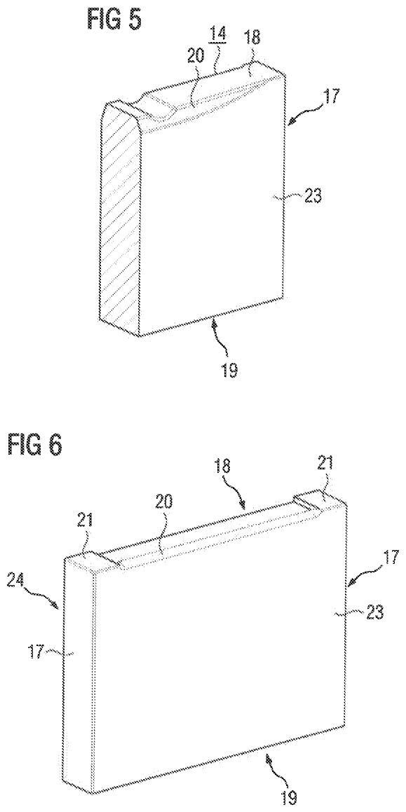

FIG. 2 to FIG. 6 show embodiments of permanent magnets according to the invention,

FIG. 7 to FIG. 11 show method steps of the production method according to the invention,

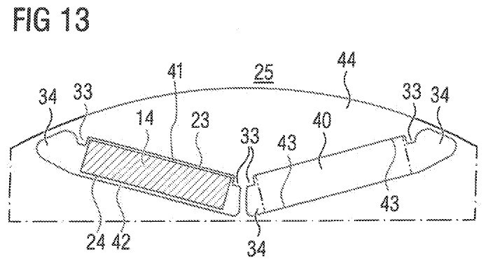

FIGS. 12 and 13 show partial cross sections of a rotor.

It should be noted that terms such as “axial”, “radial”, “tangential” etc. refer to the axis 6 used in the respective figure or in the example described in each case. In other words: the directions axial, radial, tangential always refer to an axis 6 of the rotor 9 and thus to the corresponding axis of symmetry of the stator 8. In this case, “axial” describes a direction parallel to the axis 7, “radial” describes a direction orthogonal to the axis 6, toward or away from it, and “tangential” is a direction that is at a constant radial distance from the axis 6 and, in the case of a constant axial position, directed in a circular manner around the axis 6. The expression “in the circumferential direction” is equivalent to “tangential”.

In relation to a surface, for example a cross-sectional surface, the terms “axial”, “radial”, “tangential” etc. describe the orientation of the normal vector of the surface, I.e. the vector that is perpendicular to the surface concerned.

The expression “coaxial components”, for example coaxial components such as the rotor 9 and the stator 8, is understood here as meaning components that have the same normal vectors, that is to say for which the planes defined by the coaxial components are parallel to one another. Furthermore, the expression is intended also to convey that the center points of coaxial components lie on the same axis of rotation or axis of symmetry. However, these center points may possibly lie at different axial positions on this axis and the planes mentioned may therefore be at a distance of >0 from one another. The expression does not necessarily require that coaxial components have the same radius.

The term “complementary” in connection with two components that are “complementary” to one another means that their outer forms are designed in such a way that the one component can preferably be arranged completely in the component complementary to it, so that the inner surface of one component and the outer surface of the other component ideally touch without any gaps or over the entire surface area. Consequently, in the case of two objects that are complementary to one another, the outer form of one object is therefore determined by the outer form of the other object. The term “complementary” could be replaced by the term “inverse”.

For the sake of clarity, sometimes in cases where components are multiply present, in the figures often not all the components shown are provided with reference signs.

FIG. 1 shows a basic longitudinal section of a dynamo-electric machine 1. In this example, a stator 8 with a winding system 7, which is arranged in substantially axially extending slots 16, Is arranged in a housing 2. The housing 2 is supported on a shaft 5 by means of bearings 4 via end plates. A rotor 9 is provided spaced apart from the stator 8 by an air gap 25, the rotor having permanent magnets 14 in substantially axially extending recesses 13. Both the laminated cores 10, 11 of stator 8 and rotor 9 can optionally have axially extending cooling channels in order in this way to permit a closed inner cooling circuit within the housing 2. When the winding system 7 of the stator 8 is energized, the shaft 5 is rotated about an axis 6 by electromagnetic interaction with the rotor 9. This rotation brings about driving of a work machine, not illustrated, and of a dedicated fan 15 in the housing 2.

FIGS. 2 to 6 show non-limiting examples of permanent magnets 14 which are configured according to the invention and with which the method can be particularly advantageously implemented. A permanent magnet 14, which has a cuboidal basic structure, has the following sides. The permanent magnet 14 has a cuboidal basic structure with six sides. The mutually opposite sides of the permanent magnet 14 that in later use in the laminated core 11 of the rotor 9 face the flux barriers 34 are referred to as flux barrier sides 17. The mutually opposite sides of the permanent magnet 14 that in later use in the laminated core 11 of the rotor 9 are aligned axially parallel with their normal vectors and face the end faces of the laminated core 11 are referred to as the delivery side 18 or thrust side 19. The mutually opposite sides of the permanent magnet 14 that in later use in the laminated core 11 of the rotor 9 lie perpendicularly in a magnetic flux are referred to as the air gap side 23 or axle side 24.

According to the invention, portions of the delivery side 18 and adjoining regions on at least one side located in the magnetic flux, i.e., either the air gap side 23 and/or axle side 24 are configured or materially abraded in sections. As a result, the cuboidal basic structure of the permanent magnet 14 is fluidically shaped in such a way that, during an axial movement of the permanent magnet 14 in the magnet pocket 40, an adhesive 29 placed onto the delivery side 18 is distributed via the gaps 41, 42 between the air gap side 23 and the magnet pocket 40 and the axle side 24 and the magnet pocket 40 without wetting the flux barriers 34.

In other words-at least the delivery side 18 of the permanent magnet 14 has such a hydrodynamic contour.

The edges or the portions between the delivery side 18 and at least one magnetic field side 23, 24 have a fluidic or curved configuration in order, when the permanent magnet 14 is pushed 30 axially into the axially extending recess 13, to distribute sufficient adhesive between the magnetic field sides 23, 24 and the corresponding sides of the magnet pockets 40 in the laminated core 11.

In this region, the edges of the permanent magnets 14 have flat surface elements or curved transitions from the delivery side 18 to at least one magnetic field side 23, 24.

For pushing the permanent magnets 14 into the magnet pocket 40 of the laminated core 11, the laminated core 11 is preferably oriented horizontally in such a way that the recesses 13 to be fitted are arranged substantially at the bottom.

According to the method according to FIGS. 7 to 11, an exemplary device for carrying out the method is shown, with each of the figures showing a basic cross section and longitudinal section of two laminated cores 11. For reasons of clarity, each pole 44 is illustrated only with one tangential, simplified recess 13. The recesses 13 themselves are assembled, as FIG. 12 and FIG. 13 show, from the magnet pockets 40 and the flux barriers 34 and optimum holding elements 33. Similarly, each pole 44 can have a plurality of recesses 13, for example V arrangements, U arrangements or double V arrangements.

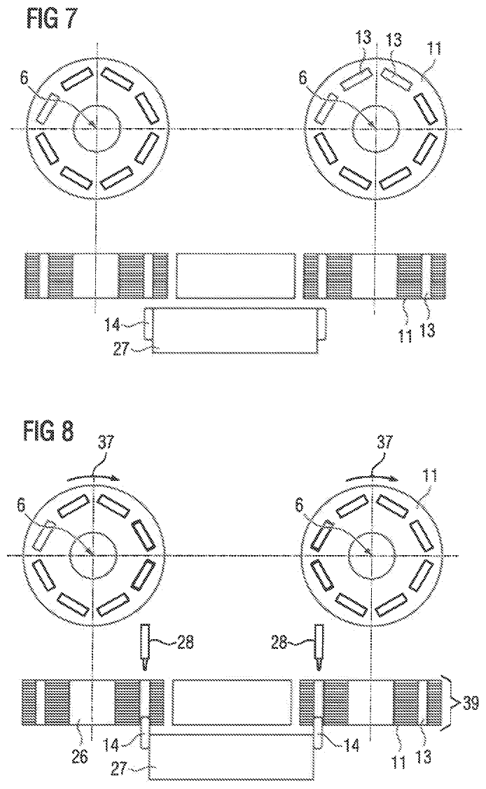

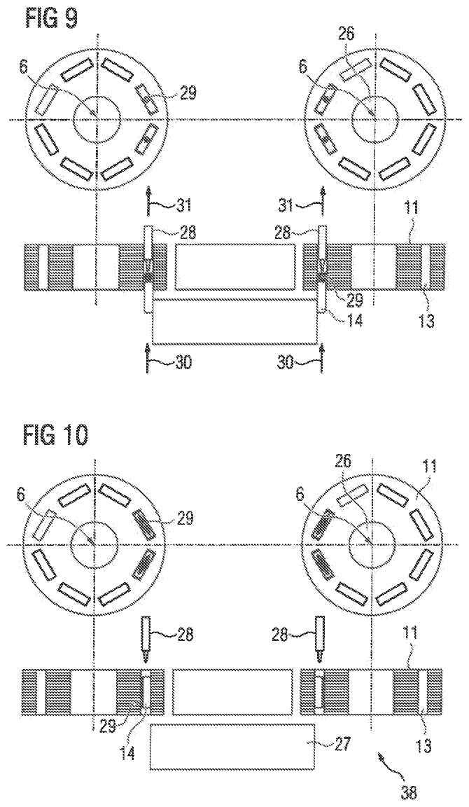

First of all, the permanent magnet 14 is pushed approx. 2 to 3 mm from an end face, with the delivery side 18 in front, into its magnet pocket 40 (FIG. 8). This push-in side of the magnet pocket 40 is therefore covered by the contour of the permanent magnet 14. The flux barriers 34 of the recess 13 remain free. An additional silicone covering is not required, Adhesive 29 is then applied to the delivery side 18 of the permanent magnet 14 by means of one or more nozzles 28. Optimally, in the center point of said surface. Special contours are introduced on the delivery side 18 and optionally on the adjoining regions of the air gap side 23 and/or axle side 24, the special contours distributing the adhesive 29 to the air gap side 23 and axle side 24 during further axial displacement of the permanent magnet 14 into the magnet pocket 40. The nozzle 28 and permanent magnet 14 ideally move synchronously in the axial direction (FIG. 9, FIG. 10).

In other words: the axial advance 31 of the nozzle 28 and the axial advance 30 of the permanent magnet 14 are Identical. This can be ensured, inter alia, by an optional counterholder of the device being provided on the delivery side 18 of the permanent magnet 14 in order to avoid the permanent magnet 14 jumping ahead because of its magnetic tensile forces in the magnet pocket 40, in particular in the axial direction.

The contours of the permanent magnet 14 on the delivery side 18 can be rectilinear or oval bevels 20. In addition, optionally with a channel or a trough 22 arranged transversely to the permanent magnet 14, the bevels 20, for example, can thereby be optimally supplied with adhesive 29 from the delivery side 18 to the magnetic field sides 23, 24.

By means of this trough, it is, inter alia, possible, with just one nozzle 31 per magnet pocket 40, to supply the adhesive process with sufficient adhesive 29. This is important in particular if the magnet height (distance between the two magnetic field sides) is smaller than 4 mm.

Other geometries of the configuration of the delivery side 18 and the adjoining regions of the magnetic field sides 23, 24 for distributing the adhesive 29 are possible. The two bevels 20 can thus be configured differently in order in this way to provide the two magnetic field sides 23, 24 with different quantities of the adhesive 29. Thus, for example, according to FIG. 13, the gap 41 on the air gap side 23 of the permanent magnet 14 can be supplied only with 30% of the adhesive volume, while the gap 42 on the axle side 24 receives 70% of the adhesive volume.

The channel or the trough 22 on the delivery side 18 of the permanent magnet 14 can also be inclined or closed on one side in order to ensure correct distribution of the adhesive 29.

Therefore, a distribution of adhesive occurs which depends on the volume flow of the adhesive 29 and the axial fitting speed of the permanent magnet 14 into the magnet pocket 40. With the viscosity of the adhesive 29 being set, it is also possible to influence the distribution of the adhesive 29 in the bevel 20 and thus the planar impingement (magnetic field side 23, 24 to the inner side 43 of the magnet pocket 40).

It is important that the bevel 20 does not reach as far as the side surfaces of the permanent magnet 14, i.e., flux barrier sides 17. It is therefore avoided that, during an axial movement of the permanent magnet 14, the adhesive 29 can run away laterally into the flux barriers 34.

This remaining ridge 21 thus prevents the adhesive 29 from running away into the flux barriers 34.

The filling of the magnet pocket 40 with the permanent magnet 14, which is located therein and moves axially, can thus be carried out continuously for each magnet pocket 40. After the fitting of each of the magnet pockets 40, the laminated core 11 is rotated further by a predeterminable angle 37 in order to fit the following magnet pockets 40. The nozzle 28 and the push-in element, in particular as part of a fitting device 38 for the permanent magnet 14, can each be moved synchronously and equidistantly so that the volume of adhesive in the gaps between the magnetic field sides 23, 24 and the inner sides 41, 42 of the magnet pocket 40 is uniformly maintained.

In order to avoid the permanent magnet 14 jumping ahead because of its magnetic tensile forces in the laminated core 11, counterholders can be provided in the fitting device 38 on the delivery side 18 of the permanent magnet 14, and therefore, during the fitting, the permanent magnet 14 is fixed in the axial direction in the tool.

If the permanent magnet 14 is pushed completely into the magnet pocket 40, the delivery of the adhesive 29 from the nozzle 28 is broken off. A possibly protruding drop of adhesive finally flushes out the bevel 20 and adhesive 29 does not protrude over the end face of the laminated core 11.

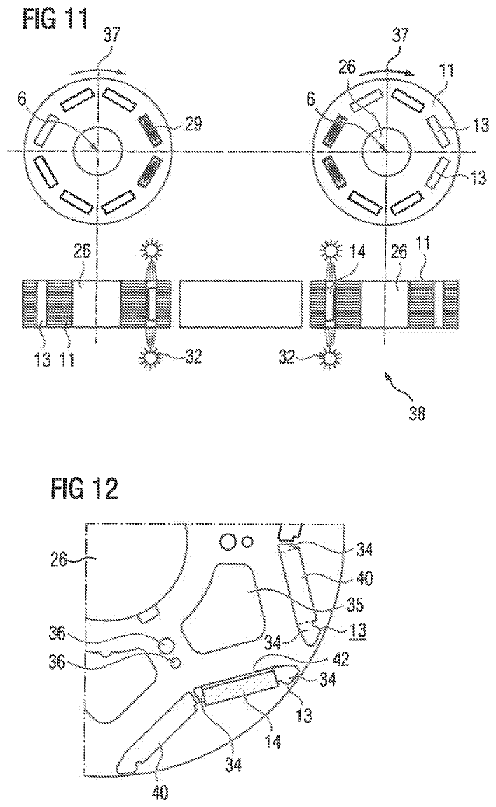

In order to permit a direct, temporally following further processing of the rotor 9, each magnet pocket 40, after being fitted with its permanent magnet 14, can optionally be subjected to UV light on its end faces, in particular on the adhesive surfaces. According to FIG. 11, the light hardening 32 takes place simultaneously or in succession. Similarly, all of the end faces of the magnet pockets 40 of a rotor 9 can also be hardened simultaneously. For this purpose, the adhesive 29 has to be provided with UV-hardening substances. The rotor 9 is therefore suitable for further handling and can subsequently completely harden through at room temperature.

The permanent magnets 14 are supplied from a magazine 27, and therefore, optimally, the permanent magnets 14 generally bear against the radial outer side of the magnet pocket 40 and the gap 41 between the air gap side 23 of the permanent magnet 14 and the inner side 41 of the magnet pocket 40 is minimized.

According to this method, the permanent magnets 14 can be pushed magnetized, partially magnetized or unmagnetized into the magnet pockets 40 and may then later possibly be completely magnetized.

The permanent magnets are supplied-as already described-from the magazine 27 which is oriented in such a manner that the permanent magnets 14 being pushed in generally bear against the inner side 43 of the magnet pocket 40, the inner side facing the outer circumference.

The adhesion of the permanent magnet 14 being pushed in on the outer side of the magnet pocket 40 can already be secured by a holding contour of the magnet pocket 40 in the lamination section of the rotor laminated core 11. Holding elements 33 are provided at the edges of the magnet pocket 40 toward the flux barriers 24 which face the outer circumference of the rotor 9, i.e., the air gap 25 of the dynamo-electric machine 1. Said holding elements 33 additionally also increase the short-circuit resistance of a dynamo-electric machine 1, in particular a permanently excited synchronous machine with buried permanent magnets 14.

The bearing of the permanent magnets 14, which, inter alia, can also be Influenced by the configuration of the delivery side 18 thereof, is of advantage with regard to the fact that the centrifugal force acting on the permanent magnets 14 during the operation of the dynamo-electric machine 1 can be better supported by the lamination geometry. In addition, during the manufacturing process of the rotor 9, the distribution of the adhesive 29 is thereby oriented toward a thus determined dimension of the gap 41.

The permanent magnets 14 (air gap side 23) advantageously bear directly against the outer side of the magnet pocket 40.

Directly bear is understood here as meaning that the permanent magnets bear directly against the lamination-only small unevennesses in the um range are present.

On the axle side of the magnet pocket, there is a distance between the permanent magnet and lamination of approx. 0.15 to 0.25 mm.

In this method for producing a rotor 9 having buried permanent magnets 14 according to the invention, the adhesive 29 is placed and fixed by means of its resulting hydrodynamic effect in the joining gaps 41, 42 between the inner sides 43 of the magnetic field pockets 40 and the magnetic field sides 23, 24. The bevels 20 on the permanent magnet 14 form a type of deposit of the adhesive 29 which, during the filling process, depending on the advance 30 of the permanent magnet 14, ensures that sufficient adhesive 29 is supplied.

The formation of bubbles or imperfections on the adhesive surfaces between the magnetic field sides 23, 24 and the corresponding inner sides 43 of the magnet pockets 40 are thus also avoided. The adhesive 29 is prevented from running away into the flux barriers of the recesses by the special contour, in particular ridges 21. According to the invention, the flux barriers 34 therefore remain free from adhesive 29.

Sealing at the tool of the fitting device 38, by means of silicone, in particular on the end faces of the magnet pockets 40, is not required. An outlay on cleaning of the tool, and scraping off of the end faces are not required.

Preheating of the laminated core 11 of the rotor 9 is not required since, in this adhesive method, the adhesive 29 is wedged into the adhesive gaps/joining gaps 41, 42 by hydrodynamic pressure formation, and the previous high dependency of the functions of gravity effect, capillary effect and viscosity of the adhesive for the fixing of the permanent magnets in the magnet pocket 40 is no longer present.

FIG. 12 shows an exemplary partial cross section of a rotor 9, in which, In order to explain the substantive matter, only one magnet pocket 40 is provided with a permanent magnet 14. In addition, the rotor 9 has inertia recesses 35 and cooling channels 36.

FIG. 13 shows a pole 44 with recesses 13 which are arranged in a V shape, with, just for clarity, also just one magnet pocket 40 being provided with a permanent magnet 14.

The gaps 41 and 42 can be formed differently here.

In order now to be able to provide even axially longer rotors 9 for corresponding dynamo-electric machines 1, said laminated cores 11, which are fitted with permanent magnets 14, can be arranged axially in succession, in particular also fastened to the shaft 5 for rotation therewith. The individual laminated cores 11 can be offset by a predeterminable angle in relation to one another in the circumferential direction in order thus to stagger the poles 44 of the rotor 9 over the entire axial length. This can reduce the torque ripple.

Rotors 9 of this type are used especially in dynamo-electric machines 1, for example permanently excited synchronous machines, which are operated especially in the industrial environment. They are provided here as drives of pumps, fans, compressors, roller conveyors and delivery systems which have a very long, continuous operating duration. Dynamo-electric machines 1 of this type are also usable in traction drives, such as mining vehicles, electric buses, trams or trains in order, inter alia, by increasing the opposing field stability, to ensure more reliable operation.

In principle, dynamo-electric machines 1 of this type can be used as motors or generators.

### LIST OF REFERENCE SIGNS

1 dynamo-electric machine
2 housing
3 end plate
4 bearing
5 shaft
6 axis
7 winding system
8 stator
9 rotor
10 laminated core of stator
11 laminated core of rotor
12 cooling channel of stator
13 recess of rotor for the permanent magnets
14 permanent magnet
15 intrinsic rotor
16 slots of stator
17 side surface of permanent magnets (facing flux barriers)
18 delivery side of the permanent magnet
19 thrust side of the permanent magnet
20 bevel
21 ridge
22 transverse channel
23 air gap side of the permanent magnet
24 axle side of the permanent magnet
25 air gap
26 laminated core bore of rotor
27 magazine
28 nozzle
29 adhesive
30 advance of permanent magnet
31 advance of nozzle
32 light hardening
33 holders
34 flux barrier
35 inertia recess
36 cooling channel of rotor
37 direction of rotation
38 fitting device
39 axial height of laminated core of rotor
40 magnet pocket
41 gap between air gap side of permanent magnet and inner side of magnet pocket
42 gap between axle side of permanent magnet and inner side of magnet pocket
43 inner side of magnet pocket
44 pole

1.-14. (canceled)

15. A method for producing a rotor of a dynamo-electric machine, the method comprising:
forming a magnet pocket and flux barriers in an axially extending, circumferentially closed recess of a laminated core for receiving a permanent magnet in the magnet pocket with two opposite flux barrier sides facing flux barriers, with a delivery side and a thrust side on two opposite sides and facing end faces, and with an air gap side and an axle side as two magnetic field sides;
forming portions of the delivery side and/or adjoining regions of at least one of the air gap side and the axle side located in a magnetic flux with a curved or fluidic configuration in at least one section;
adding an adhesive to the delivery side of the permanent magnet; and
pushing the permanent magnet with the delivery side in front axially into the magnet pocket such that the adhesive is distributed via a gap between the air gap side and the magnet pocket and a gap between the axle side and the magnet pocket without wetting the flux barriers, thereby adhesively bonding and burying the permanent magnet in the magnet pocket.

16. The method of claim 15, wherein the permanent magnet has a cuboidal basic structure.

17. The method of claim 15, wherein the adhesive is added by moving a nozzle synchronously and equidistantly at least in one section in the magnet pocket as the permanent magnet is being pushed in.

18. The method of claim 15, further comprising setting the gap between the air gap side of the permanent magnet and a corresponding inner side of the magnet pocket via a configuration of the delivery side of the permanent magnet and/or holding elements on a side of the magnet pocket facing an outer circumference of the rotor and/or an external magnetic field.

19. The method of claim 15, wherein the permanent magnet, before being pushed into the magnet pocket, is magnetized or at least partially magnetized or unmagnetized.

20. The method of claim 15, further comprising assembling two or more of said laminated core axially to form an overall laminated core in a staggered arrangement, as viewed axially, by assembling the laminated cores, as viewed in a circumferential direction, axially offset by a predeterminable identical or different angle in a range from 0° up to 30°.

21. The method of claim 15, further comprising designing at least one section of an edge between at least one of the two magnetic field sides and the delivery side of the permanent magnet with the curved or fluidic configuration.

22. The method of claim 15, further comprising designing at least one section of a region or edges between the two magnetic field sides and the delivery side of the permanent magnet by flat surfaces.

23. The method of claim 15, further comprising designing at least one section of a region or edges between the two magnetic field sides and the delivery side of the permanent magnet to be round.

24. The method of claim 15, further comprising forming the delivery side of the permanent magnet with a transverse channel or trough.

25. The method of claim 15, further comprising forming the delivery side of the permanent magnet with a symmetrical edge configuration with respect to its longitudinal axis or transverse axis.

26. The method of claim 15, further comprising forming the delivery side of the permanent magnet with an asymmetrical edge configuration with respect to its longitudinal axis or transverse axis,

27. The method of claim 15, further comprising forming ends of the delivery side of the permanent magnet with ridges in a direction of the flux barrier sides.

28. A dynamo-electric machine, comprising a rotor produced by the method of claim 15.

29. The dynamo-electric machine of claim 28, constructed in a form of a permanently excited synchronous machine.

30. The dynamo-electric machine of claim 28, for use as a drive of pumps, fans, compressors, roller conveyors and delivery systems.
